(19) United States
(12) Patent Application Publication
(10) Pub. No.: US 2026/0022776 A1
(43) Pub. Date: Jan. 22, 2026

(54) FLOW PATH FORMING DEVICE

(71) Applicant: DENSO CORPORATION, Kariya-city (JP)

(72) Inventor: Shinji NODA, Kariya-city (JP)

(21) Appl. No.: 19/345,279

(22) Filed: Sep. 30, 2025

Related U.S. Application Data
(63) Continuation of application No. PCT/JP2024/013170, filed on Mar. 29, 2024.

(30) Foreign Application Priority Data
Apr. 7, 2023 (JP) 2023-062944

(51) Int. Cl. F16K 11/085; F01P 7/14

(52) U.S. Cl. CPC F16K 11/0856; F01P 2007/146

(57) ABSTRACT

A flow path forming device includes a structure including multiple fluid paths independent from each other. The multiple fluid paths include adjacent fluid paths which are adjacent to each other, offset in a predetermined assembly direction and cross each other independently. The structure is assembled from two separate members: a first member and a second member, which are combined in the assembly direction and joined together.

### CROSS REFERENCE TO RELATED APPLICATIONS

The present application is a continuation application of International Patent Application No. PCT/JP2024/013170 filed on Mar. 29, 2024, which designated the U.S. and claims the benefit of priority from Japanese Patent Application No. 2023-062944 filed on Apr. 7, 2023. The disclosures of all the above applications are incorporated herein.

### TECHNICAL FIELD

The present disclosure relates to a flow path forming device.

### BACKGROUND ART

A pump device with a multi-way valve is adopted in a thermal management system in a vehicle.

### SUMMARY

A flow path forming device includes a structure including multiple fluid paths independent from each other. The multiple fluid paths include adjacent fluid paths which are adjacent to each other, offset in a predetermined assembly direction and cross each other independently. The structure is assembled from two separate members: a first member and a second member, which are combined in the assembly direction and joined together.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a schematic configuration diagram of a fluid control system including a flow path forming device according to a first embodiment.

FIG. 2 is a schematic perspective view of the flow path forming device.

FIG. 3 is a schematic exploded perspective view of the flow path forming device.

FIG. 4 is a schematic perspective view showing a first member.

FIG. 5 is a schematic perspective view showing a second member.

FIG. 6 is a schematic perspective view of the second member, which is seen from the direction of the arrow VI in FIG. 5.

FIG. 7 is a cross-sectional view taken along the line VII-VII of FIG. 5.

FIG. 8 is a schematic configuration diagram illustrating the first member and the second member before and after joining them.

FIG. 9 is a schematic configuration diagram of a fluid control system including a manifold, according to a comparative example to the first embodiment.

FIG. 10 is a schematic perspective view of the manifold according to the comparative example to the first embodiment.

FIG. 11 is a schematic exploded perspective view of the manifold according to the comparative example to the first embodiment.

FIG. 12 is a schematic exploded perspective view of a flow path forming device according to a first modification of the first embodiment.

FIG. 13 is a schematic exploded perspective view of the flow path forming device seen from the direction of the arrow XIII in FIG. 12.

FIG. 14 is a schematic exploded perspective view of a flow path forming device according to a second modification of the first embodiment.

FIG. 15 is a schematic exploded perspective view of the flow path forming device seen from the direction of the arrow XV in FIG. 14.

FIG. 16 is a schematic configuration diagram of a fluid control system including a flow path forming device according to a third modification of the first embodiment.

FIG. 17 is a schematic diagram of a flow path forming device according to the second embodiment.

FIG. 18 is a schematic perspective view of the flow path forming device according to the second embodiment.

FIG. 19 is a schematic perspective view of the flow path forming device seen from the direction of the arrow XIX in FIG. 18.

FIG. 20 is a schematic planar view of the flow path forming device.

FIG. 21 is a cross-sectional view taken along the line XXI-XXI of FIG. 20.

FIG. 22 is a schematic planar view of a second member.

FIG. 23 is a schematic diagram illustrating a face of a valve device to which the flow path forming device is secured.

FIG. 24 is a schematic exploded perspective view of the flow path forming device.

FIG. 25 is a schematic perspective view of a flow path forming device according to another embodiment.

FIG. 26 is a schematic exploded perspective view of a flow path forming device according to another embodiment.

### DETAILED DESCRIPTION

According to a comparative example, a pump device with a multi-way valve is adopted in a thermal management system in a vehicle. In the pump device, a flow path forming device, which allows fluid to flow into and out of the multi-way valve, includes an integrated plate body in which multiple flow paths are formed, and a pair of end plates holding the integrated plate body between the end plates.

For example, if the number of functional components outside a flow path forming device increases, the flow paths within the flow path forming device become more complex. This results in increase in flow path length and pressure loss, which in turn reduce the thermal utilization efficiency in the thermal management system. Additionally, the flow path forming device may become large and decrease its installability in vehicles.

Based on these facts, the inventors have explored a structure in which flow paths are offset and crossing independently in order to shorten the flow path length in the flow path forming device. Joining three or more members can realize the structure in which the flow paths are offset and crossing independently. However, there are concerns about occurrence of fluid leakage due to increase in the number of joints, and about cost increase due to rise in the number of parts. There are similar concerns even when the number of functional components outside the flow path forming device is small.

In contrast, according to the present disclosure, a flow path forming device includes flow paths that are offset and crossing independently and is capable of reducing the number of joined members.

A flow path forming device includes a structure including multiple fluid paths independent from each other. The multiple fluid paths include adjacent fluid paths which are adjacent to each other, offset in a predetermined assembly direction and cross each other independently. The structure is assembled from two separate members: a first member and a second member, which are combined in the assembly direction and joined together.

As the above configuration, if the adjacent fluid paths have at least parts arranged to be offset in the assembly direction and crossing independently, it is possible to avoid interference between the fluid paths while increasing the packing density of the fluid paths.

Additionally, in the flow path forming device of the present disclosure, the two separate members: the first member and the second member, are joined to form the adjacent fluid paths having at least the parts offset and crossing independently. The number of the joined members can be decreased and the independent flow paths are offset and crossing independently.

In particular, compared to realize a structure in which flow paths are offset and crossing independently by joining of three or more members, the flow path forming device in the present disclosure can decrease the number of the joints between the members and prevent the fluid from leaking from the joints between the members. Additionally, the effect of cost reduction due to the small number of parts can be also expected.

Herein, the term “independent flow path” refers to a flow path that does not communicate with another flow path within the flow path forming device. The term does not specify the relationship with another flow path outside the flow path forming device. The independent flow path may communicate with another flow path outside the flow path forming device. The adjacent fluid paths include a section in which the adjacent fluid paths are close to each other without another flow path interposed between the adjacent flow paths.

The embodiments of the present disclosure will be described below with reference to the drawings. In the following embodiments, portions that are the same as or equivalent to those described in a preceding embodiment are denoted by the same reference numerals, and a description of the same or equivalent portions may be omitted. When only some of the configuration elements are described in the embodiment, the remaining configuration elements can be referred from those described in the preceding embodiment. The following embodiments may be partially combined with each other even if such a combination is not explicitly described as long as there is no disadvantage with respect to such a combination.

### First Embodiment

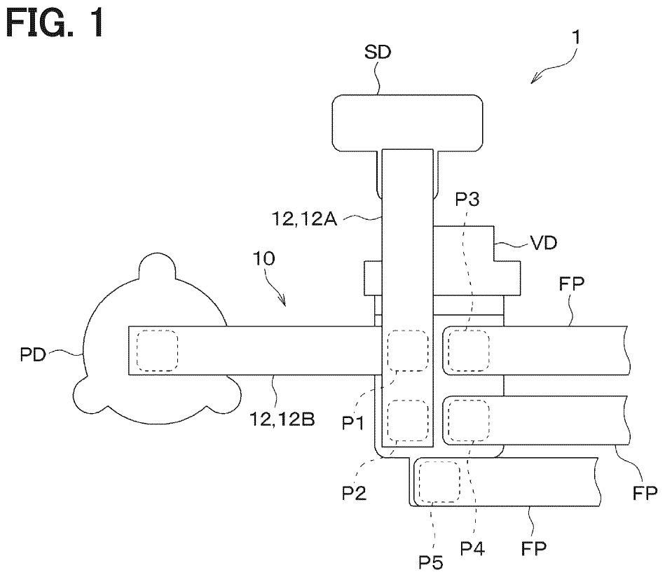

The present embodiment will be described with reference to FIGS. 1 to 8. In the present embodiment, an example, in which a flow path forming device 10 in the present disclosure is applied to a fluid control system 1 installed in an electric vehicle, will be described.

The fluid control system 1 is a heat distribution system that appropriately distributes heat generated by a refrigeration cycle and various heat-generating devices to various devices that require heat, via a fluid that serves as a heat transfer medium.

As shown in FIG. 1, the fluid control system 1 includes fluid devices such as: a pump device PD that generates fluid flow, a valve device VD that switches a fluid path, and a thermal device SD that serves as a temperature control target or a heat source. Additionally, the fluid control system 1 includes the flow path forming device 10 that connects the fluid devices such as the pump device PD, the valve device VD, and the thermal device SD. The fluid control system 1 also includes an unillustrated fluid circulation circuit that comprises multiple fluid pipes FP.

In the present embodiment, the valve device VD is configured as a five-way valve with five ports P1 to P5. In the valve device VD, the flow path forming device 10 is connected to a first port P1 and a second port P2, while the fluid pipes FP are connected to a third port P3, a fourth port P4, and a fifth port P5.

In FIG. 1, the fluid control system 1 is illustrated with one pump device PD, one valve device VD, one thermal device SD, and one flow path forming device 10, but it is not limited to this configuration. The fluid control system 1 may have a configuration different from the configuration illustrated in FIG. 1.

The flow path forming device 10 is a manifold collectively including multiple flow paths, through which the fluid flows. The fluid flowing through the multiple fluid paths of the flow path forming device 10 is a coolant. The coolant may be an antifreeze, but it may be a liquid containing water other than the antifreeze.

The flow path forming device 10 includes a structure 12 that includes multiple fluid paths independent from each other. The structure 12 is connected to an external device through which the fluid is allowed to flow in or flow out via, for example, the fluid paths.

The structure 12 has a substantially T-shaped outer form in planar view. Specifically, the structure 12 includes a first part 12A that extends linearly, and a second part 12B combined with the first part 12A. One end of the second part 12B is connected to an intermediate section of the first part 12A in the extending direction of the first part 12A. The second part 12B extends linearly and perpendicular to the first part 12A. In the structure 12, the first part 12A and the second part 12B may be combined so as to cross diagonally.

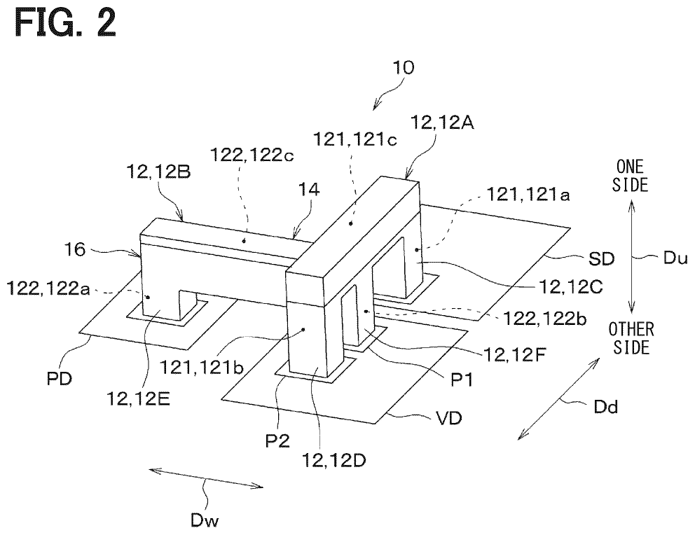

As illustrated in FIG. 2, in the structure 12, legs 12C and 12D are provided respectively at positions corresponding to opposite ends of the first part 12A, and legs 12E and 12F are provided respectively at positions corresponding to opposite ends of the second part 12B.

Each leg 12C, 12D, 12E, 12F is a section to which an external device is connected. The legs 12C and 12D extend substantially perpendicular to the extending direction of the first part 12A. The legs 12E and 12F extend substantially perpendicular to the extending direction of the second part 12B. In this example, although the legs 12C, 12D, 12E and 12F have same length in their extending directions, their lengths may be different.

In the structure 12 of the present embodiment, three legs 12C, 12D, and 12F are arranged in a row in the extending direction of the first part 12A. Specifically, in the structure 12, the leg 12F provided at the end of the second part 12B is positioned between the two legs 12C and 12D that are provided at opposite ends of the first part 12A.

The structure 12 of the present embodiment includes a first fluid path 121 connecting the thermal device SD and the valve device VD, and a second fluid path 122 connecting the pump device PD and the valve device VD. In the present embodiment, fluid devices, such as the pump device PD, the valve device VD, and the thermal device SD, constitute an “external device”.

The first fluid path 121 includes a first connection port 121a connected to the thermal device SD, a second connection port 121b connected to the valve device VD, and a first intermediate flow path section 121c connecting the first connection port 121a and the second connection port 121b. The first intermediate flow path section 121c is formed inside the first part 12A of the structure 12. The first connection port 121a is formed inside the leg 12C provided at an end of the first part 12A. The second connection port 121b is formed inside the leg 12D provided at other end of the first part 12A.

The second fluid path flow 122 includes a third connection port 122a connected to the pump device PD, a fourth connection port 122b connected to the valve device VD, and a second intermediate flow path section 122c connecting the third connection port 122a and the fourth connection port 122b. The second intermediate flow path section 122c is formed inside the second part 12B of the structure 12. The third connection port 122a is formed inside the leg 12E provided at an end of the second part 12B. The fourth connection port 122b is formed inside the leg 12F provided at other of the second part 12B.

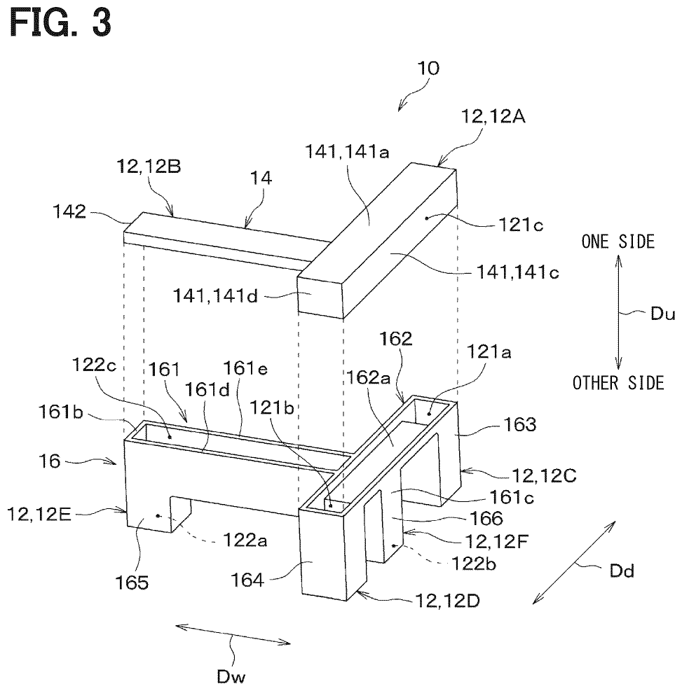

At least a part of the first fluid path 121 and at least a part of the second fluid path 122 are offset in an assembly direction Du described later and crossing independently. As illustrated in FIG. 3, the structure 12 is assembled by combining two separate members, which are a first member 14 and a second member 16, in the predetermined assembly direction Du.

Herein in the present embodiment, a first direction perpendicular to the assembly direction Du is referred to a lengthwise direction Dd, and a second direction perpendicular to both the assembly direction Du and the lengthwise direction Dd is referred to the widthwise direction Dw. The orientation of the structure 12 illustrated in FIGS. 2 and 3 is one example. The orientation of the structure 12 with being installed in a vehicle is not limited to the orientation illustrated in, for example, FIGS. 2 and 3.

The first member 14 and the second member 16 are each formed of a thermoplastic resin. The first member 14 and the second member 16 are injection-molded parts made with a mold, and are formed in a shape without an undercut so that the mold can be taken out in the assembly direction Du.

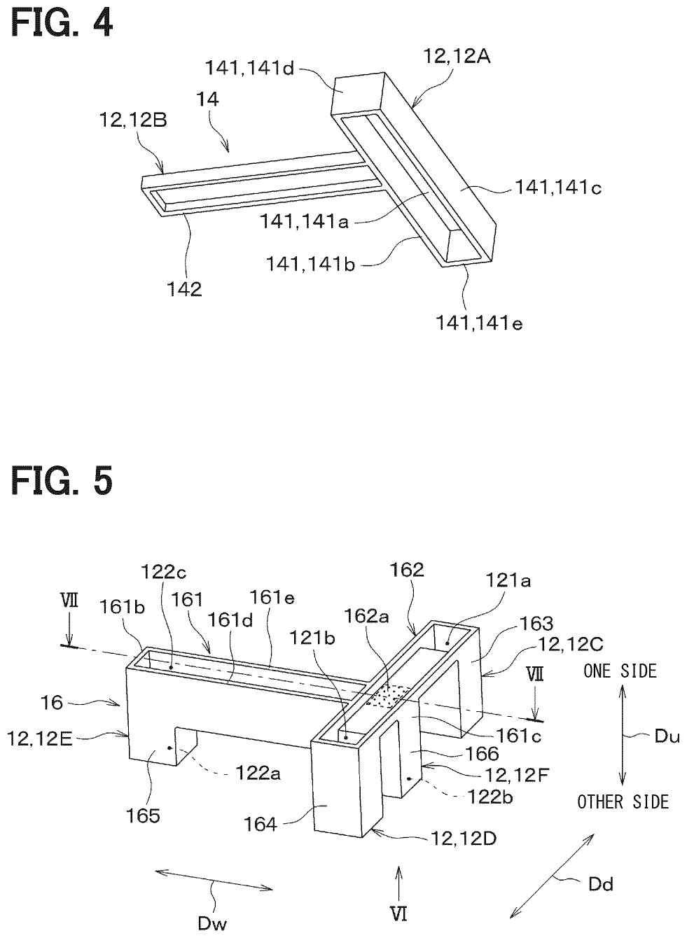

First, the first member 14 will be described. The first member 14 is positioned on one side of the second member 16 in the assembly direction Du. As illustrated in FIGS. 3 and 4, the first member 14 is a molded part and includes a first recess 141 and a first cover 142 molded together. The first recess 141 has an opening on other side of the first member 14 in the assembly direction Du facing the second member 16. In the present embodiment, the first recess 141 corresponds to a “first flow path section” and the first cover 142 corresponds to a “fourth flow path section”.

The first recess 141 forms a part of the first part 12A and extends along the lengthwise direction Dd. The first recess 141 includes a first bottom wall 141a extending along the lengthwise direction Dd, and four first side wall 141b, 141c, 141d, and 141e protruding from four sides of the first bottom wall 141a toward the other side of the first member 14 in the assembly direction Du.

The first cover 142 constitutes a part of the second part 12B and extends in the widthwise direction Dw. One end of the first cover 142 in the widthwise direction Dw is connected to the first side wall 141b of the first recess 141.

The first member having the above configuration is a molded part in which the first recess 141 and the first cover 142 is molded together. Since the first member 14 does not include sections facing each other in the assembly direction Du, the first member 14 has the shape without undercut so that the mold can be taken out in the assembly direction Du.

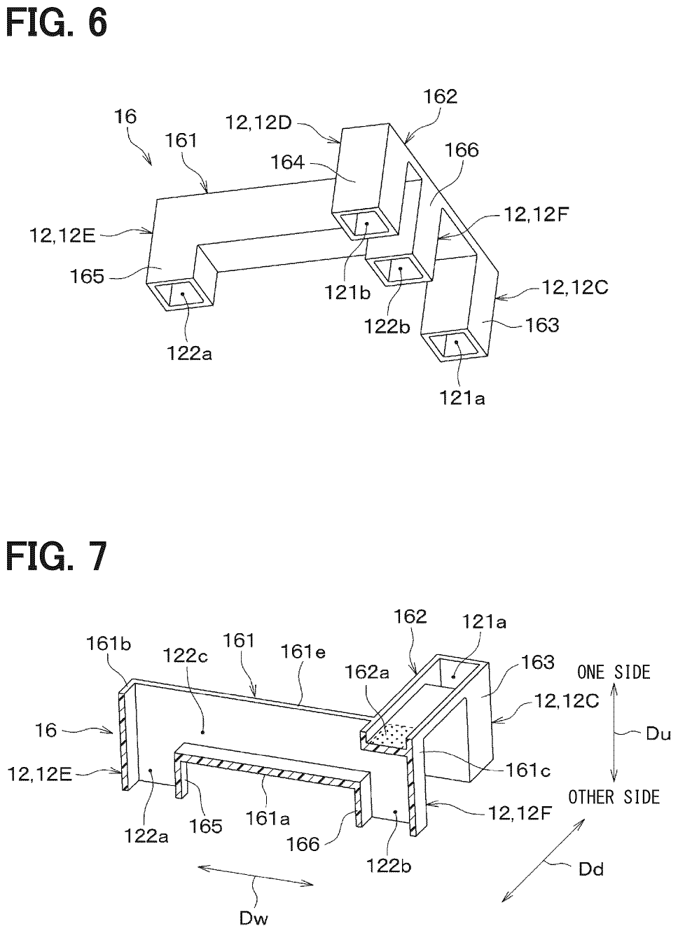

Next, the second member 16 will be described. The second member 16 is positioned on the other side of the first member 14 in the assembly direction Du. As illustrated in FIGS. 5 to 6, the second member 16 is a molded part in which a second recess 161, a second cover 162, a first cylinder 163, a second cylinder 164, a third cylinder 165, and a fourth cylinder 166 are molded together. In the present embodiment, the second recess 161 constitutes a “third flow path section” and the second cover 162 constitutes a “second flow path section”.

The second recess 161 forms a part of the second part 12B and extends along the widthwise direction Dw. The second recess 161 has an opening on the one side of the second member 16 in the assembly direction Du. The second recess 161 includes a second bottom wall 161a extending along the widthwise direction Dw, and four second side wall 161b, 161c, 161d, and 161e protruding from four sides of the second bottom wall 161a toward the one side of the second member 16 in the assembly direction Du.

Specifically, as illustrated in FIGS. 5 and 7, an opening of an end part of the second recess 161 in the widthwise direction Dw is closed by the second cover 162, and an opening of other part of the second recess 161 is open on the one side of the second member 16 in the assembly direction Du.

The second cover 162 forms a part of the second part 12B and extends along the lengthwise direction Dd. The second cover 162 is connected to the second recess 161 such that the opening of the end part of the second recess 161 in the widthwise direction Dw is covered by the second cover 162. The section of the second cover 162 covering the second recess 161 constitutes an intersection forming section 162a. The first fluid path 121 and the second fluid path 122 are offset and crossing with the intersection forming section 162 separating them. In other words, the intersection forming section 162a serves as a partition wall that partitions the first intermediate flow path section 121c and the second intermediate flow path section 122c.

Other side of the second cover 162 in the assembly direction Du is connected to the first cylinder 163 and the second cylinder 164. Specifically, the second cover 162 has one end in the lengthwise direction Dd connected to the first cylinder 163 and other end in the lengthwise direction Dd connected to the second cylinder 164.

The first cylinder 163 is the rectangular tube-shaped part forming the leg 12C. The first cylinder 163 is connected to the second cover 162 and protrudes from the other side of the second cover 162 in the assembly direction Du. The first cylinder 163 has an opening on the other side of second member 16 in the assembly direction Du, and the opening is connected to the thermal device SD. The first connection port 121a is formed inside the first cylinder 163. The first connection port 121a is open on the other side of the second member 16 in the assembly direction Du.

The second cylinder 164 is the rectangular tube-shaped part forming the leg 12D. The second cylinder 164 is connected to the second cover 162 and protrude from the other side of the second cover 162 in the assembly direction Du. The second cylinder 164 has an opening on the other side of second cylinder 164 in the assembly direction Du, and the opening is connected to the valve device VD. The second connection port 121b is formed inside the second cylinder 164. The second connection port 121b is open on the other side of the second member 16 the assembly direction Du.

Additionally, other side of the second recess 161 in the assembly direction Du is connected to the third cylinder 165 and the fourth cylinder 166. Specifically, one end of the second recess 161 in the widthwise direction Dw is connected to the third cylinder 165, and another end of the second recess 161 in the widthwise direction Dw is connected to the fourth cylinder 166.

The third cylinder 165 is the rectangular tube-shaped part forming the leg 12E. The third cylinder 165 is connected to the second recess 161 and protrudes from the other side of the second recess 161 in the assembly direction Du. The third cylinder 165 has an opening on the other side of third cylinder 165 in the assembly direction Du, and the opening is connected to the pump device PD. The third connection port 122a is formed inside the third cylinder 165. The third connection port 122a is open on other side of the third cylinder 165 in the assembly direction Du.

The fourth cylinder 166 is the rectangular tube-shaped part forming the leg 12F. The fourth cylinder 166 is connected to the second recess 161 and protrudes from the other side of the second recess 161 in the assembly direction Du. The fourth cylinder 166 has an opening on other side of the fourth cylinder 166 in the assembly direction Du, and the opening is connected to the valve device VD. The fourth connection port 122b is formed inside the fourth cylinder 166.

Specifically, the fourth cylinder 166 is connected to a section of the second recess 161 covered by the intersection forming section 162a of the second cover 162. As a result, the fourth connection port 122b is open in the assembly direction Du away from the first member and allows the intersection forming section 162a to be exposed to an outside of the second member 116 in the assembly direction Du through the fourth connection port 122b.

The second member 16 having the above configuration is the molded part in which the second recess 161, the second cover 162, the first cylinder 163, the second cylinder 164, the third cylinder 165, and the fourth cylinder 166 are molded together. Since the second member 16 does not include sections facing each other in the assembly direction Du, the second member 16 has the shape without an undercut so that the mold can be taken out in the assembly direction Du.

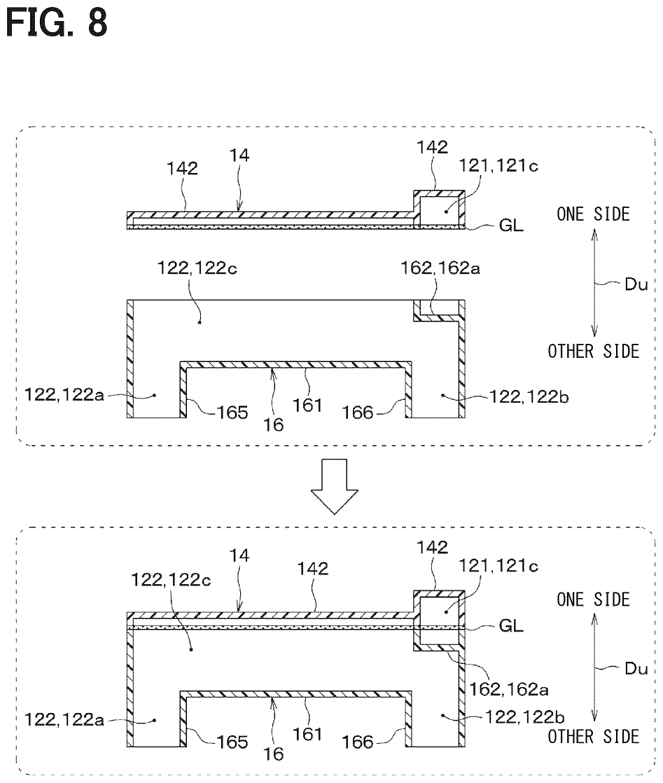

As illustrated in FIG. 8, the structure 12 of the fluid path forming device 10 is assembled by combining and joining the first member 14 and the second member 16 in the assembly direction Du. The first member 14 and the second member 16 are joined by one of bonding methods: adhesion, welding, or fusion. Specifically, the structure 12 is formed by joining the first member 14 and the second member 16 with an adhesive GL.

However, it is desirable that a bonding method used to join the first member 14 and the second member 16 is determined according to the constituent materials of the first member 14 and the second member 16.

For example, when the first member 14 and the second member 16 are made of a resin material with poor wettability, bonding of the first member 14 and the second member 16 with the adhesive GL may result in inadequate bonding strength and heat resistance. In this case, for example, it is desirable to join the first member 14 and the second member 16 by welding. As a result, adequate bonding strength and heat resistance can be secured. Additionally, it is expected to reduce the risk of volatile organic compounds being released during the drying of the adhesive GL and the generation of toxic gases during incineration of the adhesive GL.

When the first member 14 and the second member 16 are formed of a metal material, it is desirable to join the first member 14 and the second member 16 by fusion. As a result, adequate bonding strength and heat resistance can be secured. Additionally, it is expected to reduce the risk of volatile organic compounds being released during the drying of the adhesive GL and the generation of toxic gases during incineration of the adhesive GL.

In the structure 12 obtained in this manner, a part of the first fluid path 121 and a part the second fluid path 122 are offset in the assembly direction Du and cross each other.

The first intermediate flow path section 121c of the first fluid path 121 is enclosed by the first recess 141 and the second cover 162. The first recess 141 is formed in the first member 14, and the second cover 162 is formed at a position facing the first recess 141 in the second member 16. The second intermediate flow path section 122c of the second fluid path 122 is enclosed by the second recess 161, the first cover 142 and the intersection forming section 162a. The second recess 161 is formed in the second member 16, the first cover 142 is formed at a position facing the second recess 161 in the first member 14, and the intersection forming section 162a is formed in the second cover 162. The first intermediate flow path section 121c and the second intermediate flow path section 122c are separated by the intersecting formation area 162a so that they do not communicate with each other. As a result, the first fluid path 121 and the second fluid path 122 are formed as the flow paths independent from each other.

In this embodiment, the first fluid path 121 corresponds to a “first flow path” which is one of two adjacent fluid paths positioned on one side in the assembly direction Du, and the second fluid path 122 corresponds to a “second flow path” which is the other of the two adjacent fluid paths positioned on the other side in the assembly direction Du.

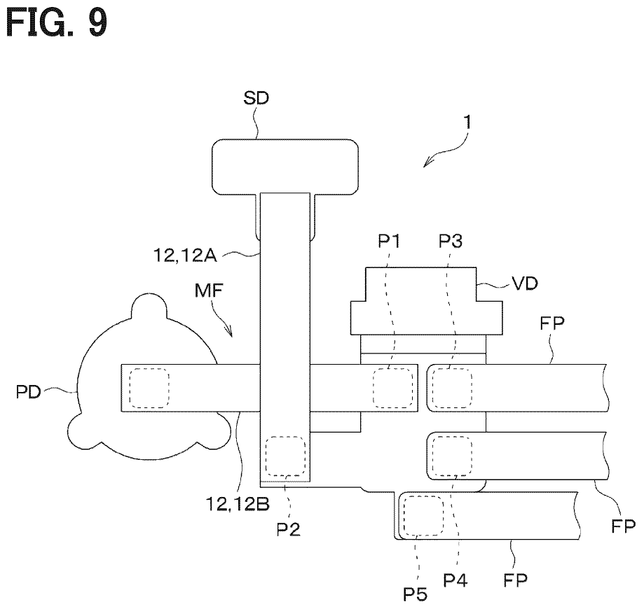

Herein, FIGS. 9 to 11 are explanatory diagrams for describing a manifold MF, which is a comparative example of the flow path forming device 10. The manifold MF according to the comparative example has an outer shape which is substantially cross-shaped in planar view. For the convenience in explanation, a component of the manifold MF, which corresponds to the component of the flow path forming device 10, is assigned the same reference numeral as what is given to the component of the flow path forming device 10.

As illustrated in FIG. 9, the manifold MF is formed by combination of a first part 12A, which extends linearly in a lengthwise direction Dd, and a second part 12B, which extends linearly in a widthwise direction Dw across the first part 12A.

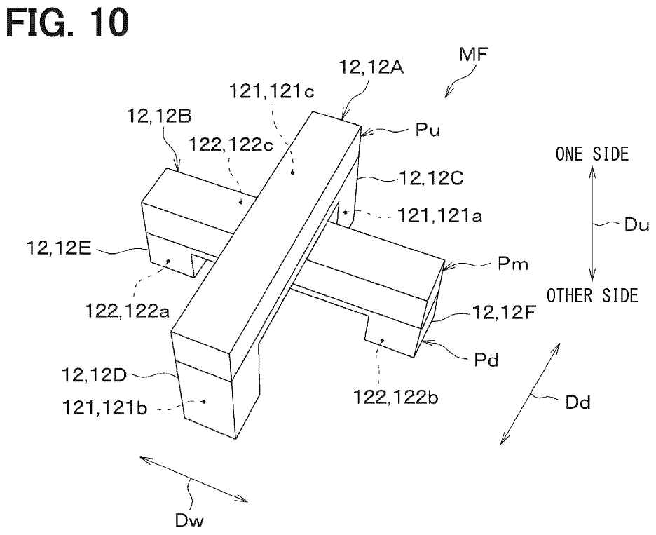

As illustrated in FIG. 10, in the manifold MF, legs 12E and 12F, which are provided at opposite ends of the second part 12B, are arranged not to overlap two legs 12C an 12D, which are provided at opposite ends of the first part 12A in an extending direction of the first part 12A.

In the manifold MF, a first intermediate flow path section 121c of a first fluid path 121 is formed inside the first part 12A, and a first connection port 121a is formed inside the leg 12C, and a second connection port 121b is formed inside the leg 12D. Additionally, in the manifold MF, a second intermediate flow path section 122c of a second fluid path 122 is formed inside the second part 12B, and a third connection port 122a is formed in the leg 12E, and a fourth connection port 122b is formed in the 12F.

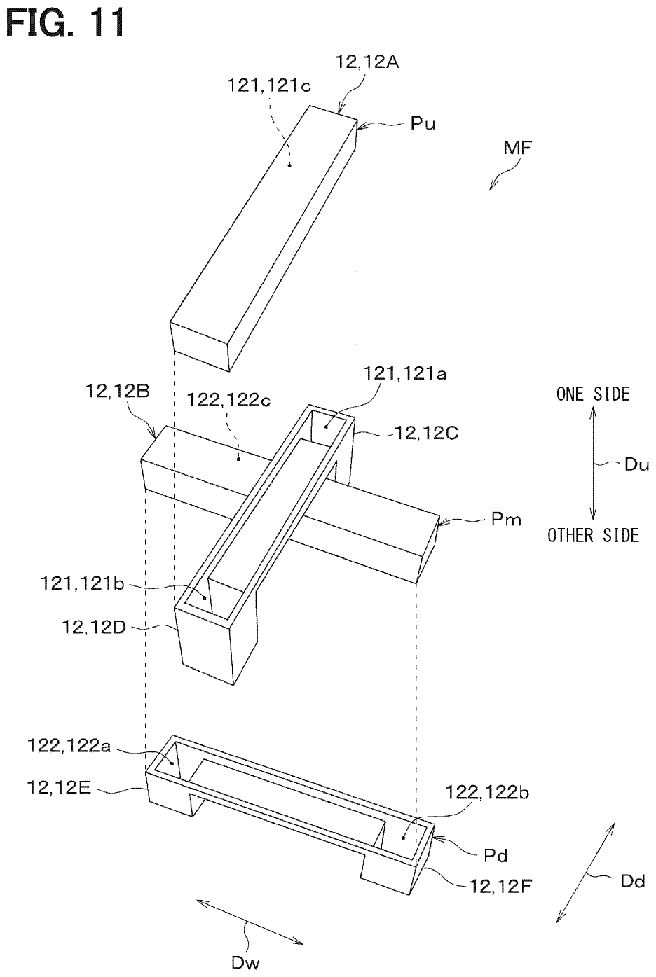

In the manifold MF, the two rectangular tube-shaped parts that form the fluid paths 121 and 122 are arranged side by side in an assembly direction Du at the position where the first part 12A and the second part 12B cross each other. As a result, three or more members are required to form the manifold MF due to manufacturing limitations and the like. For example, as illustrated in FIG. 11, the assembly of the manifold MF can be completed by combining and joining three members: an upper part Pu, a lower part Pd, and a middle part Pm. However, when three or more members are used to form the manifold MF, the number of joints between the members may increase. Therefore, there are concerns about fluid leakage due to increase in the number of joints and cost increase due to rise in the number of parts.

In contrast, according to the flow path forming device 10 of the present embodiment, at least parts of the first fluid path 121 and the second fluid path 122, which are adjacent to each other, are offset and cross each other due to the joining of the two separate members: the first member 14 and the second member 16. Accordingly, the number of the joined members can be reduced, and the flow paths can be offset and cross each other independently. As a result, fluid leakage from a joint between members can be decreased. Additionally, the effect of cost decrease due to the small number of parts can be also expected.

Additionally, the flow path forming device 10 in the present embodiment includes the following features.

(1) Specifically, the first fluid path 121 is enclosed by the first recess 141 and the second cover 162. The first recess 141 is provided on the first member 14 and is open on the other side of the first member 14 in the assembly direction Du. The second cover 162 is located at the position of the second member 16 facing the first recess 141. The second fluid path 122 is enclosed by the second recess 161, the first cover 142 and the intersection forming section 162a. The second recess 161 is provided on the second member 16 and is open on the one side of the second member 16 in the assembly direction Du. The first cover 142 is located at the position of the first member 14 facing the second recess 161. The intersection forming section 162a of the second cover 162 is provided at the position at which the first fluid path 121 and the second fluid path 122 are offset and cross independently. The first fluid path 121 and the second fluid path 122 are separated by the intersection forming section 162a. The first member 14 is the molded part in which the first recess 141 and the first cover 142 are molded together. The second member 16 is the molded part in which the second recess 161 and the second cover 162 are molded together. Accordingly, the structure, in which at least parts of the adjacent fluid paths are offset and crossing, can be realized due to the joining of the two separate members: the first member 14 and the second member 16.

(2) The first fluid path 121 includes the first connection port 121a and the second connection port 121b which allow the fluid to flow into and out of the first flow path 121 from and to an external device. The first fluid path 121 includes the first intermediate flow path section 121c connecting both the connection ports. The second fluid path 122 includes the third connection port 122a and the fourth connection port 122b which allow fluid to flow into and out of the second fluid path 122 from and to the external devices. The second fluid path 122 includes the second intermediate flow path section 122c connecting both the connection ports. Additionally, parts of the first intermediate flow path 121c and the second intermediate flow path 122c, which are adjacent each other, are offset in the assembly direction Du and crossing each other. Accordingly, the first intermediate flow path 121c and the second intermediate flow path 122c, which are adjacent each other, can be avoided to interfere with each other, and the packing density of the first intermediate flow path 121c and the second intermediate flow path 122c can be increased.

(3) When the intersection forming section 162a of the second member 16 and the second bottom wall 161a of the second recess 161 are overlapped with each other in the assembly direction Du, a manufacturing process of the second member 16 may become complicated due to a manufacturing constraint, such as undercut.

Therefore, the second member 16 of the present embodiment has an opening which allows the intersection forming section 162a to be exposed to the outside of the second member 16 via the fourth connection port 122b of the second fluid path 122 and a part of the second intermediate flow path 122c from the other side of the second member 16 in the assembly direction Du. As described above, since the intersection forming section 162a is exposed to the outside of the second member 16 via the fourth connection port 122b continuous to the second intermediate flow path 122c from the other side of the second member 16 in the assembly direction Du, the decrease of productivity of the second member 16 due to a manufacturing constraint such as undercut can be reduced.

(4) The third connection port 122a of the second fluid path 122 is open on the other side of the second member 16 in the assembly direction Du. As described above, since a pair of the connection ports 122a and 122b of the second fluid path 122 are open in the assembly direction Du, the pair of the connection ports 122a and 122b can be prevented from being the manufacturing constraint such as undercut.

(5) A pair of connection ports 121a and 121b of the first fluid path 121 of the second member 16 are open in the assembly direction Du. As described above, since the pair of the connection ports 121a and 121b of the first fluid path 121 are open in the assembly direction Du, the pair of the connection ports 121a and 121b can be prevented from being the manufacturing constraint such as undercut.

(6) In case of joining the first member 14 and the second member 16 by mechanical fastening using fastening members such as bolts and screws, fastening members and sealing materials are needed. Therefore, the number of members increases.

In contrast, in the structure 12 of the present embodiment, the first member 14 and the second member 16 are joined by one of the bonding methods: adhesion, welding, or fusion. Accordingly, since fastening members, such as bolts and screws, and sealing materials can be omitted and the number of components can be decreased, cost reduction can be implemented.

(7) The fluid flowing through the first fluid path 121 and the second fluid path 122 is the coolant. The flow path forming device 10 of the present embodiment can decrease the leakage of the coolant in the structure where at least parts of the first fluid path 121 and the second fluid path 122, which are adjacent to each other, are offset and cross independently.

### Modification of the First Embodiment

In the aforementioned first embodiment, the flow path forming device 10 of the present disclosure is described in detail. However, the description above is merely an example. The first embodiment is not limited to the description, and for example, can be modified as follows.

### First Modification

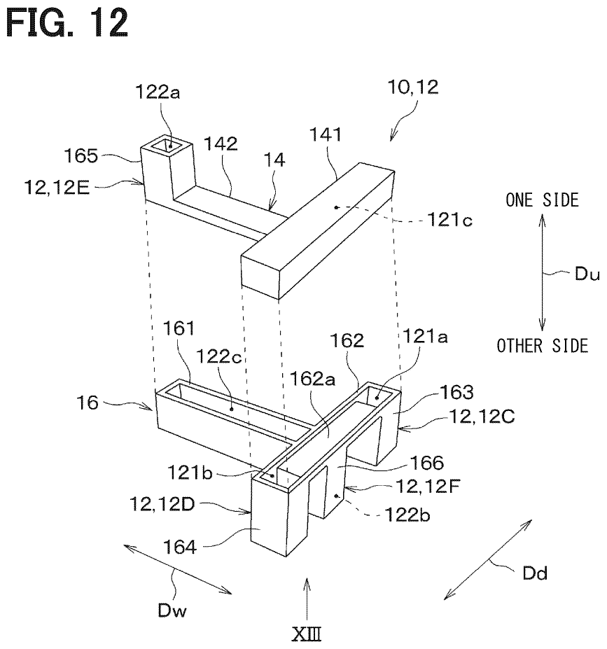

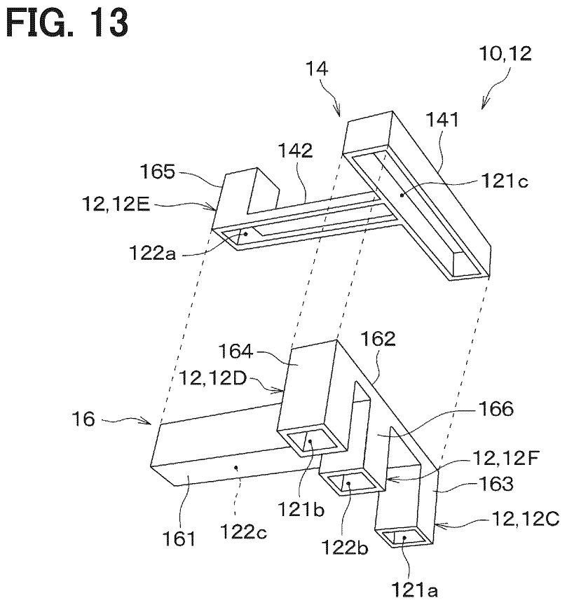

For example, as illustrated in FIGS. 12 and 13, the flow path forming device 10 may include a structure in which a leg 12E is not provided on a second member 16, but on a first member 14. The leg 12E may protrude from one side of the first member 14 in the assembly direction Du. In this case, a third connection port 122a of a second fluid path 122 is open on the one side of the first member 14 in the assembly direction Du. This modification also can prevent a pair of connection ports 122a and 122b from being manufacturing constraint such as undercut.

### Second Modification

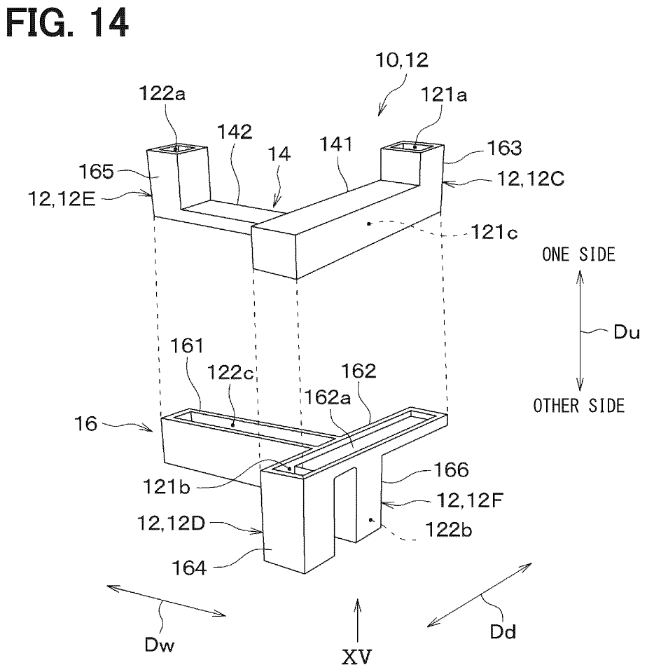

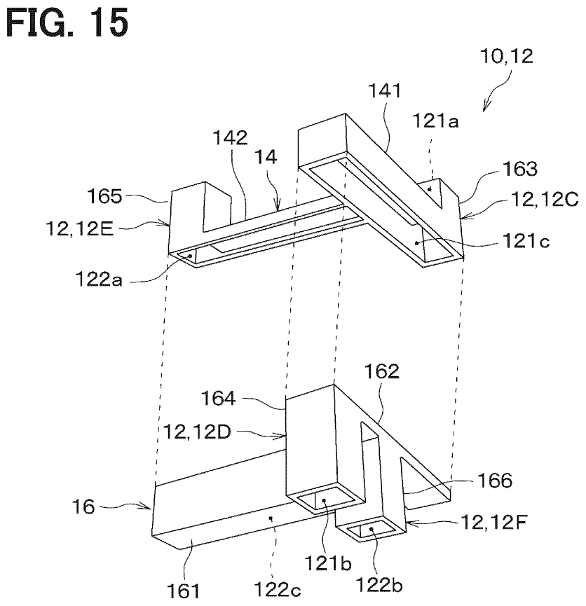

For example, as illustrated in FIGS. 14 and 15, a flow path forming device 10 may include a structure in which legs 12C and 12E are not provided on a second member 16, but on a first member 14. The legs 12C and 12E may protrude from one side of the first member 14 in the assembly direction Du. In this case, a first connection port 121a of a first fluid path 121 is open on one side of the first member 14 in the assembly direction Du. Additionally, a third connection port 122a of a second fluid path 122 is open on the one side of the first member 14 in the assembly direction Du. This modification also can prevent a pair of connection ports 122a and 122b from being manufacturing constraint such as undercut.

In the flow path forming device 10, for example, at least one of the legs 12C, 12D, and 12E may not be provided on the second member 16, but on the first member 14 and protrude from the one side of the first member 14 in the assembly direction Du.

### Third Modification

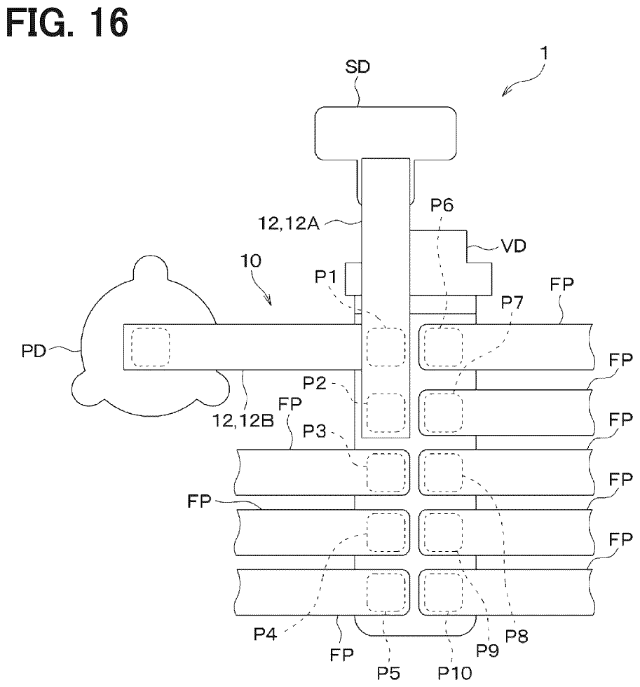

A flow path forming device 10 can be applied to a valve device VD other than five-way valves. For example, as illustrated in FIG. 16, the flow path forming device 10 is appliable to the valve device VD that is a ten-way valve with ten ports P1 to P10. An external device connected to the flow path forming device 10 may not be limited to a pump device PD, the valve device VD, and a thermal device SD, and may be a device other than these devices PD, VD and SD.

### Second Embodiment

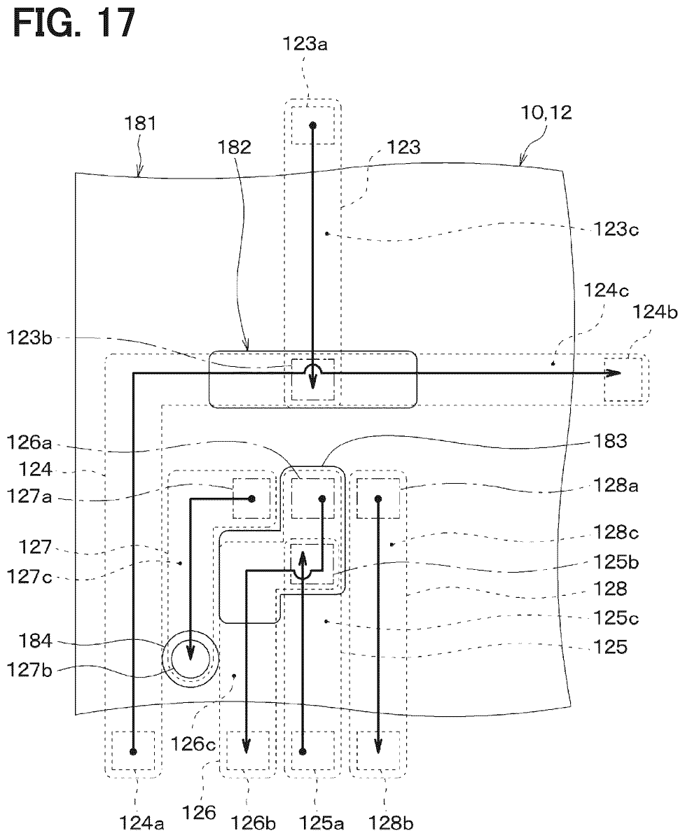

Next, a second embodiment will be described with reference to FIGS. 17 to 24. In the present embodiment, parts different from the first embodiment will be mainly described.

FIG. 17 is the schematic diagram that illustrates a part of a flow path forming device 10 according to the second embodiment. As illustrated in FIG. 17, a structure 12 forming the flow path forming device 10 includes six fluid paths: a first fluid path 123, a second fluid path 124, a third fluid path 125, a fourth fluid path 126, a fifth fluid path 127, and a sixth fluid path 128. In FIG. 17 and other drawings, the solid arrow corresponding to each of the fluid paths 123 to 128 indicates an example of a direction in which fluid flows within each of the fluid paths 123 to 128.

The first fluid path 123 includes a first connection port 123a connected to an external device that is not illustrated, a second connection port 123b connected to a valve device VD, and a first intermediate flow path section 123c connecting the first connection port 123a and the second connection port 123b.

The second fluid path 124 includes a third connection port 124a and a fourth connection port 124b, which are connected to an external device that is not illustrated, and a second intermediate flow path section 124c connecting the third connection port 124a and the fourth connection port 124b.

The third fluid path 125 includes a fifth connection port 125a connected to an external device that is not illustrated, a sixth connection port 125b connected to the valve device VD, and a third intermediate flow path section 125c connecting the fifth connection port 125a and the sixth connection port 125b.

The fourth fluid path 126 includes a seventh connection port 126a connected to the valve device VD, an eighth connection port 126b connected to an external device that is not illustrated, and a fourth intermediate flow path section 126c connecting the seventh connection port 126a and the eighth connection port 126b.

The fifth fluid path 127 includes a ninth connection port 127a connected to the valve device VD, a tenth connection port 127b connected to an external device that is not illustrated, and a fifth intermediate flow path section 127c connecting the ninth connection port 127a and the tenth connection port 127b.

The sixth fluid path 128 includes an eleventh connection port 128a connected to the valve device VD, a twelfth connection port 128b connected to an external device that is not illustrated, and a sixth intermediate flow path section 128c connecting the eleventh connection port 128a and the twelfth connection port 128b.

In the first fluid path 123 and the second fluid path 124, a part of the first intermediate flow path section 123c is adjacent to a part of the second intermediate flow path section 124c. The parts of the first intermediate flow path section 123c and the second intermediate section 124c are offset and cross independently in the assembly direction Du.

In the third fluid path 125 and the fourth fluid path 126, a part of the third intermediate flow path section 125c is adjacent to a part of the fourth intermediate flow path section 126c. The parts of the third intermediate flow path section 125c and the fourth intermediate section 126c are offset and cross independently in the assembly direction Du.

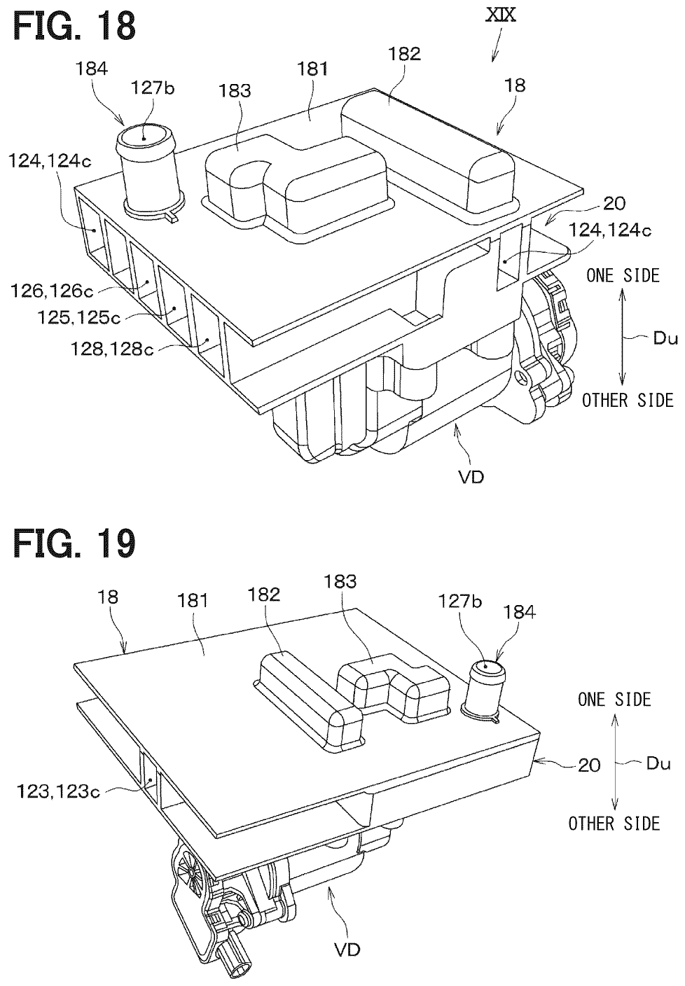

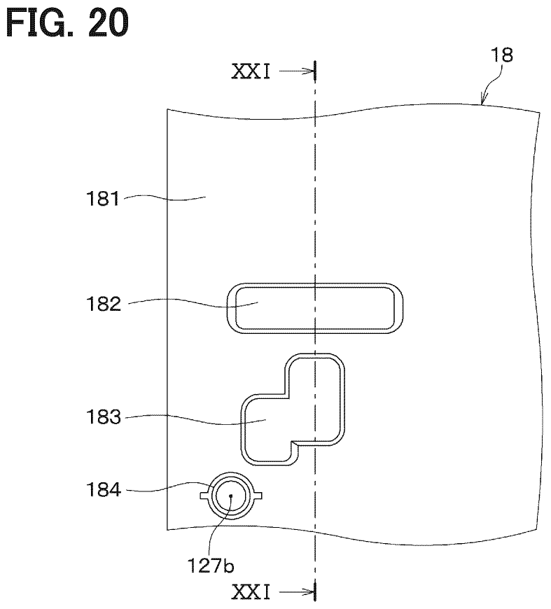

As illustrated in FIGS. 18 and 19, the structure 12 is assembled from two separated members: a first member 18 and a second member 20, which are combined in the predetermined assembly direction Du.

The first member 18 and the second member 20 are each formed of a thermoplastic resin. The first member 18 and the second member 20 are injection-molded parts made with a mold, and are formed without an undercut so that the mold can be taken out in the assembly direction Du.

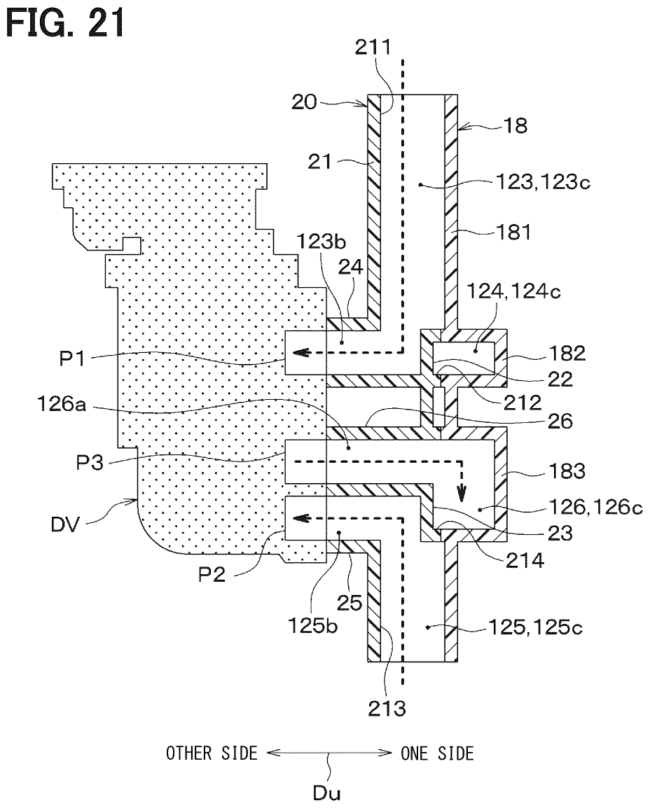

First, the first member 18 will be described. The first member 18 is positioned on one side of the second member 20 in the assembly direction Du. As illustrated in FIGS. 20 and 21, the first member 18 includes a flat section 181 that extends perpendicularly to the assembly direction Du, a first protrusion section 182 and a second protrusion section 183 that protrude out from one side of the first member 18 in the assembly direction Du, and a first connector 184 that protrudes from the one side of the first member 18 in the assembly direction Du.

The flat section 181 has a flat face on the one side of the first member 18 in the assembly direction Du. Additionally, although not illustrated, multiple protrusions are formed on other side of the flat section 181 in the assembly direction Du to abut and join with the second member 20. These protrusions are not necessary and may be omitted.

The first protrusion section 182 is provided at a position corresponding to the part of the second fluid path 124 which is offset and crosses independently the first fluid path 123. The first protrusion section 182, which faces the second member 20, is recessed toward the one side of the first member 18 in the assembly direction Du.

The second protrusion section 183 is provided at a position corresponding to the part of the fourth fluid flow path 126, which is offset and crosses independently the third fluid path 125. The section of the second protrusion section 183, which faces the second member 20, is recessed toward the one side of the first member 18 in the assembly direction Du.

The first connector 184 constitutes the tenth connection port 127b of the fifth fluid path 127 and is provided at one end of the fifth intermediate flow path section 127c. The first connector 184 is open on one side of the first connector 184 in the assembly direction Du.

The first member 18, constituted as above, is a molded part in which the flat section 181, the first protrusion section 182, the second protrusion section 183, and the first connector 184 are molded together. Since the first member 18 does not include the sections facing each other in the assembly direction Du, the first member 18 is the shape without an undercut so that the mold can be taken out in the assembly direction Du. In the present embodiment, the first protrusion section 182 and the second protrusion section 183 constitute a “first recess” that is formed on the first member 18 and open on other side of the first member 18 in the assembly direction Du, and the flat section 181 constitutes a “first cover”. Additionally, in the present embodiment, the first protrusion section 182 and the second protrusion section 183 constitute a “first flow path section”, and the flat section 181 constitutes a “fourth flow path section”.

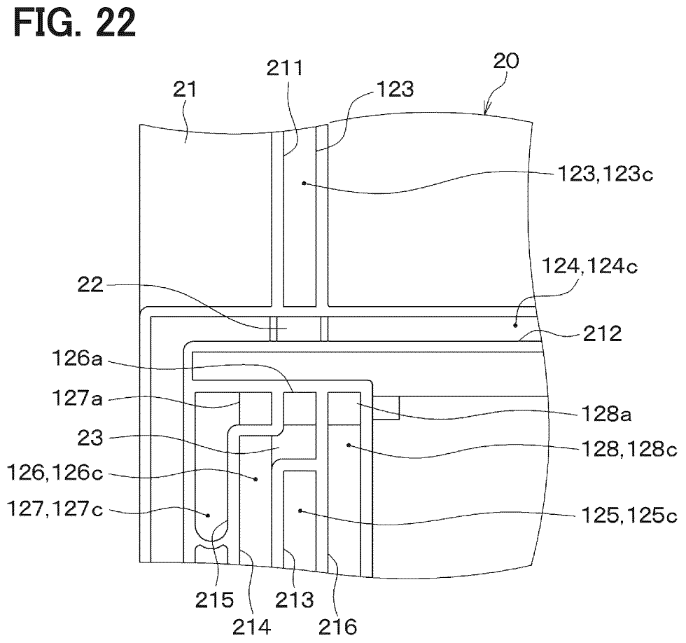

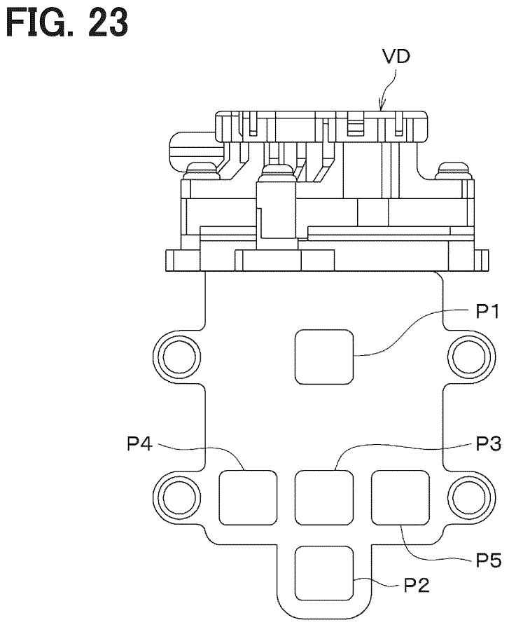

Next, the second member 20 will be described, the second member 20 is positioned on the other side of the first member 18 in the assembly direction Du. As illustrated in FIGS. 21 and 22, the second member 20 includes a base 21 including six flow path grooves 211 to 216, a first step 22, a second step 23, and second to twelfth connectors.

The base 21 has the six flow path grooves: a first flow path groove 211, a second flow path groove 212, a third flow path groove 213, a fourth flow path groove 214, a fifth flow path groove 215, and a sixth flow path groove 216.

The first flow path groove 211 is formed at the position corresponding to the first fluid path 123. The first flow path groove 211 is recessed toward other side of the second member 20 in the assembly direction Du. The first flow path groove 211 includes the section open on the one side of the second member 20 in the assembly direction Du.

The second flow path groove 212 is provided at the position corresponding to the second fluid path 124. The second flow path groove 212 is recessed toward the other side of the second member 20 in the assembly direction Du. The second flow path groove 212 is open on the one side of the second member 20 in the assembly direction Du.

The third flow path groove 213 is formed at the position corresponding to the third fluid path 125. The third flow path groove 213 is recessed toward the other side of the second member 20 in the assembly direction Du. The third flow path groove 213 includes the section open on the one side of the second member 20 in the assembly direction Du.

The fourth flow path groove 214 is formed at the position corresponding to the fourth fluid path 126. The fourth flow path groove 214 are recessed on the other side of the second member 20 in the assembly direction Du. The fourth flow path groove 214 is open on the one side of the second member 20 in the assembly direction Du.

The fifth flow path groove 215 is formed at the position corresponding to the fifth fluid path 127. The fifth flow path groove 215 is recessed at the other side of the second member 20 in the assembly direction Du. The fifth flow path wall 215 includes the section open on the one side of the second member 20 in the assembly direction Du.

The sixth flow path groove 216 is formed at the position corresponding to the sixth fluid path 128. The fourth flow path groove 216 is recessed on the other side of the second member 20 in the assembly direction Du. The sixth flow path groove 216 is open on the one side of the second member 20 in the assembly direction Du.

The first step 22 is positioned at a section of the second flow path groove 212 which crosses the first flow path groove 211. Specifically, the first step 22 is positioned at a section of the second member 20 which faces the first protrusion section 182. The first step 22 protrudes from a bottom of the second flow path groove 212 toward the one side of the second member 20 in the assembly direction Du, and covers an opening section at an end part of the first flow path groove 211. The first step 22 serves as a partition wall that separates the first intermediate flow path section 123c and the second intermediate flow path 124c. In the present embodiment, the first step 22 constitutes an “intersection forming section” in which the first intermediate flow path section 123c and the second intermediate flow path section 124c are offset and cross independently.

The second step 23 is positioned at the section of the fourth flow path groove 214, which crosses the third flow path groove 213. Specifically, the second step 23 is provided at the section of the second member 20, which faces the second protrusion section 183. The second step 23 protrudes from a bottom of the fourth flow path groove 214 toward the one side of the second member 20 in the assembly direction Du, and covers an opening section at an end part of the third flow path groove 213. The second step 23 serves as a partition wall that separates the third intermediate flow path section 125c and the fourth intermediate flow path 126c. In the present embodiment, the second step 23 constitutes an “intersection forming section” in which the third intermediate flow path section 125c and the fourth intermediate flow path section 126c are offset and cross independently.

The second to twelfth connectors are provided on other side of the base 21 in the assembly direction Du. The second to twelfth connectors protrude from the other side of the second member 20 in the assembly direction Du, facing away from the one side of the second member 20 in the assembly direction Du. The second to twelfth connectors are open on the other side of the second member 20 in the assembly direction Du. The second to twelfth connectors are connected to an external device and the valve device VD on the other side of the second member 20 in the assembly direction Du. The valve device VD of the present embodiment includes five ports P1 to P5 on the face of the valve device VD, where the flow path forming device 10 is provided.

The second connector constitutes the first connection port 123a of the first fluid path 123 and is provided at the position corresponding to an end of the first intermediate flow path 123c. The second connector is connected to an eternal device. Although not illustrated, the first connection port 123a is open on the other side of t the second member 20 in the assembly direction Du.

The third connector 24 constitutes the second connection port 123b of the first fluid path 123 and is positioned at the position corresponding to other end of the first intermediate flow path 123c. The third connector 24 is connected to the first port P1 of the valve device VD. Specifically, the third connector 24 is provided to the section of the valve device VD, at which the first step 22 is provided. The second connection port 123b has an opening on other side of the first step 22 in the assembly direction Du and allows the first step 22 corresponding to the “intersection forming section” to be exposed to the outside of the second member 20 through the opening.

The fourth connector and the fifth connector constitute the third connection port 124a and the fourth connection port 124b, respectively, and are provided at the positions corresponding to opposite ends of the second intermediate flow path section 124c. The fourth connector and the fifth connector are connected to an external device. Although not illustrated, the third connection port 124a and the fourth connection port 124b are open in the assembly direction Du.

The sixth connector constitutes the fifth connection port 125a of the third fluid path 125, and is provided at the position corresponding to an end of the third intermediate flow path section 125c. The fifth connector is connected to an external device. Although not illustrated, the fifth connection port 125a is open in the assembly direction Du.

The seventh connector 25 constitutes the sixth connection port 125b of the third fluid path 125, and is provided at the position corresponding to other end of the third intermediate flow path section 125c. The seventh connector 25 is connected to the second port P2 of the valve device VD. Specifically, the seventh connector 25 is connected to the section of the third fluid path 125 at which the second step 23 is provided. The sixth connection port 125b has an opening on other side of the second step 23 in the assembly direction Du and allows the second step 23 corresponding to the “intersection forming section” to be exposed to the outside of the second member 20 through the opening.

The eighth connector 26 constitutes the seventh connection port 126a of the fourth fluid path 126, and is provided at the position corresponding to an end of the fourth intermediate flow path section 126c. The eighth connector 26 is connected to the third port P3 of the valve device VD.

The ninth connector 26 constitutes the eighth connection port 126b of the fourth fluid path 126, and is provided at the position corresponding to other end of the fourth intermediate flow path section 126c. The ninth connector is connected to an external device. Although not illustrated, the seventh connection port 126a and the eighth connection port 126b are open in the assembly direction Du.

The tenth connector constitutes the ninth connection port 127a of the fifth fluid path 127, and is provided at the position corresponding to an end of the fifth intermediate flow path section 127c. The tenth connector is connected to the fourth port P4 of the valve device VD. Although not illustrated, the ninth connection port 127a is open on the other side of the second member 20 in the assembly direction Du.

The eleventh connector constitutes the eleventh connection port 128a of the sixth fluid path 128, and is provided at the position corresponding to an end of the sixth intermediate flow path section 128c. The eleventh connector is connected to the fifth port P5 of the valve device VD. Although not illustrated, the eleventh connection port 128a is open on the other side of the second member 20 in the assembly direction Du.

The twelfth connector constitutes the twelfth connection port 128b of the sixth fluid path 128, and is provided at the position corresponding to other end of the sixth intermediate flow path section 128c. The twelfth connector is connected to an external device. Although not illustrated, the twelfth connection port 128b is open in the assembly direction Du.

The second member 20, constituted as above, is the molded part in which the base 21, the first step 22, the second step 23, and the second to twelfth connectors are molded together. Since the second member 20 does not include sections facing each other in the assembly direction Du, the second member 20 is the shape without an undercut so that the mold can be taken out in the assembly direction Du. In the present embodiment, the six flow path grooves 211 to 216 formed on the base 21 constitute a “second recess” that is formed in the second member 20 and open on the other side of the second member 20 in the assembly direction Du. The first step 22 and the second step 23 constitute a “second cover”. Additionally, in the present embodiment, the six flow path grooves 211 to 216 formed on the base 21 constitute a “third flow path section”, the first step 22 and the second step 23 constitute a “second flow path section”.

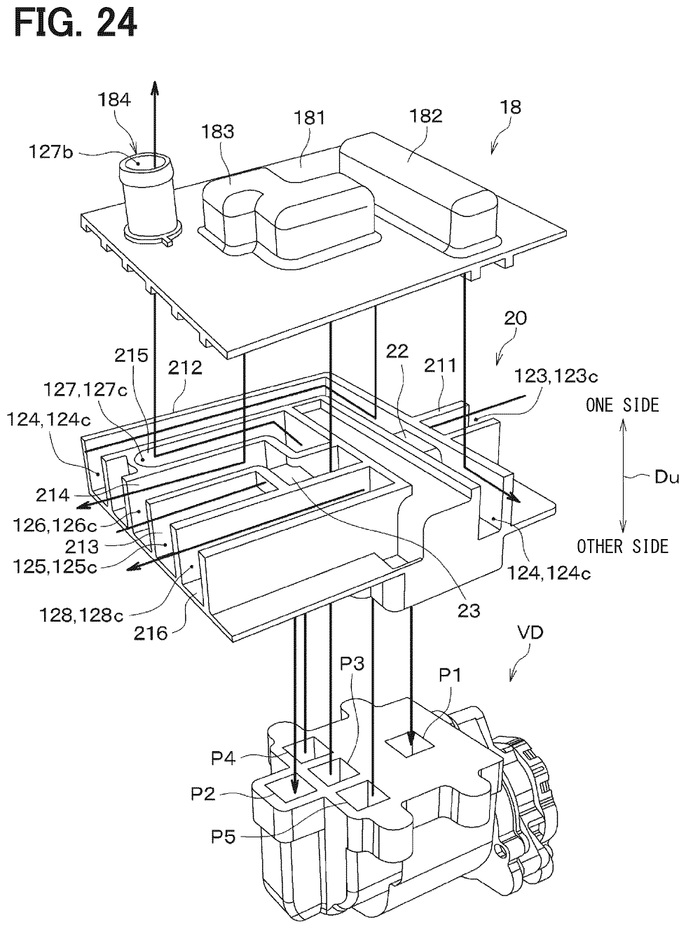

As illustrated in FIG. 24, the structure 12 of the flow path forming device 10 is assembled by the first member 18 and the second member 20, as described above, being combined and joined in the assembly direction Du. The first member 18 and the second member 20 are joined by one of the bonding methods: adhesion, welding, and fusion.

The structure 12, constituted as above, has the structure in which parts of the first intermediate flow path section 123c and second intermediate flow path section 124c are offset in the assembly direction Du and cross independently. Additionally, in the structure 12, parts of the third intermediate flow path section 125c and the fourth intermediate flow path section 126c are offset in the assembly direction Du and cross independently.

The first intermediate flow path section 123c is enclosed by the first flow path groove 211 of the second member 20, and a section of the flat section 181 of the first member 18 which faces the first flow pass groove 211. The second intermediate flow path section 124c has a part that is enclosed by the first protrusion section 182 of the first member 18 and the first step 22 of the second member 20 which faces the first recess 182. The remaining part of the second intermediate flow path section 124c is enclosed by the second flow path groove 212 of the second member 20 and the section of the flat section 181 of the first member 18 which faces the second flow path groove 212. The first intermediate flow path section 123c and the second intermediate flow path section 124c are separated by the first step 22 that is the intersection forming section so that they do not communicate with each other. Thus, the first fluid path 123 and the second fluid path 124 is each formed as an independent flow path.

The third intermediate flow path section 125c is enclosed by the third flow path groove 213 of the second member 20 and the section of the flat section 181 of the first member 18 which faces the third flow pass groove 213. The fourth intermediate flow path section 126c has a part enclosed by the second protrusion section 182 of the first member 18 and the second step 23 of the second member 20. The second step 23 faces the second recess 183. The remaining part of the fourth intermediate flow path section 126c is enclosed by the second flow path groove 212 of the second member 20 and the section of the flat section 181 of the first member 18 which faces the second flow path groove 212. The third intermediate flow path section 125c and the fourth intermediate flow path section 126c are separated by the second step 23 that is the intersection forming section so that they do not communicate with each other. Thus, the third fluid path 125 and the fourth fluid path 126 is each formed as an independent flow path.

In the present embodiment, the first intermediate flow path section 123c and the third intermediate flow path section 125c correspond to a “second flow path” which is one of intermediate flow paths adjacent to each other in the assembly direction Du. Additionally, the second intermediate flow path 124c and the fourth intermediate flow path 126c correspond to a “first flow path” which is another of the intermediate flow paths in the direction Du.

The other features are the same as those in the first embodiment. The flow path forming device 10 in the present embodiment can perform the same effect as the effect achieved by the constitutions which is common or equivalent to the first embodiment.

### Other Embodiments

The representative embodiments of the present disclosure have been described above, but the present disclosure is not limited to the embodiments described above. For example, it can be variously modified as follows.

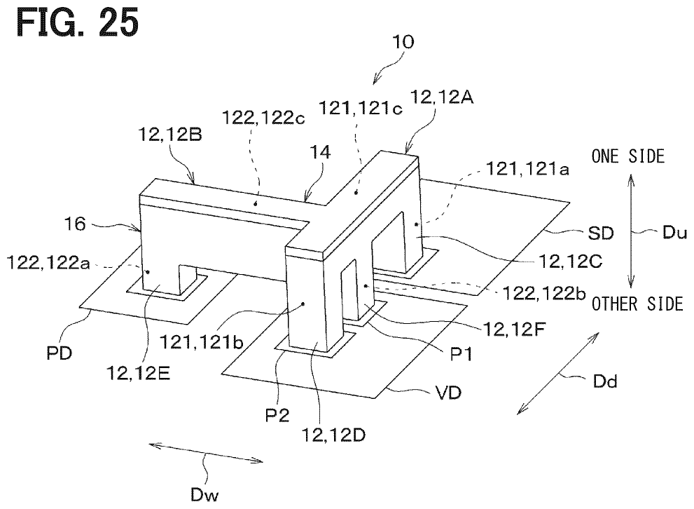

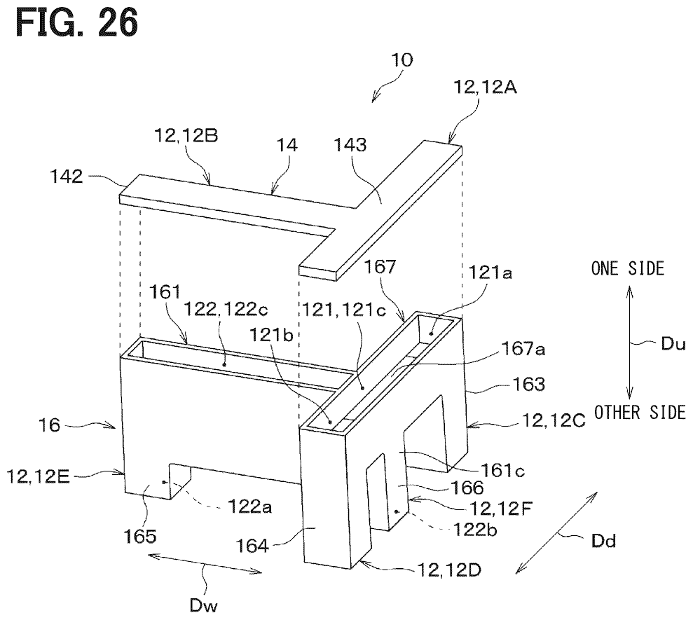

In the first embodiment, a part of the first fluid path 121 is defined by the first recess 141 of the first member 14 and a second cover 162 of the second member 16, but the flow path forming device 10 is limited to this example. For example, as illustrated in FIGS. 25 and 26, a flow path forming device 10 may have a first fluid path 121 defined by a first recess 167 and a second cover 143. The first recess 167 is formed in a second member 16 and open on one side of the second member 16 in an assembly direction Du, and the second cover 143 is formed in a first member 14 at a position facing the first recess 167. In the flow path forming device 10 having the above configuration, a part of a bottom of the first recess 167 constitutes an intersection forming section 167a. In the first member 14 in this example, a first cover 142 and the second cover 143 are seamlessly and continuously connected to each other, but it is not limited to this structure. For example, in the first member 14, the first cover 142 and the second cover 143 may have a positional relationship with a displacement in the assembly direction Du, resulting in a step formed between the first cover 142 and the second cover 143. Additionally, in the second member 16 in this example, a first recess 167 and the second recess 161 are seamlessly continuous to each other, but it is not limited to this structure. For example, in the second member 16, the first recess 167 and the second recess 161 may have a positional relationship with a displacement in the assembly direction Du, resulting in a step formed between the first recess 167 and the second recess 161. In this example, the first recess 167 constitutes a “second flow path section” and the first cover 142 constitutes a “first flow path section”.

In the flow path forming device 10 of the above embodiments, a flow path is formed by a recess and a cover closing an opening of the recess, but it is not limited to this structure. For example, in the flow path forming device 10, the flow path may be formed by a combination of L-shaped sections, or by a V-shaped section and a cover closing an opening of the V-shaped section. Additionally, in the flow path forming device 10, the flow path may be formed by a recess and a cover, the recess is formed in one of the first member 14 or the second member 16, and the cover is formed in other of the first member or the second member.

The flow path forming device 10, in the above embodiments, has the flow paths offset and crossing independently and the flow paths have connection ports which are open in the assembly direction Du. However, it is not limited to this structure. In the flow path forming device 10, the flow paths offset and crossing independently may have connection ports open in a direction other than the assembly direction Du.

In the flow path forming device 10 of the above embodiments, the flow paths offset and crossing independently are each connected to an external device via a pair of connection ports, but it is not limited to this structure. For example, in the flow path forming device 10, one of the flow paths that are offset and cross independently may have one end connected to an external device, and other end closed or open without being connected to an external device. In this configuration, the connection port is not necessary and may be omitted.

In the above embodiments, the flow path forming device 10 has members constituting the structure 12, and the members are joined by one of the bonding methods: adhesion, welding, and fusion, but it is not limited to these methods. In the flow path forming device 10, at least a part of the members constituting the structure 12 may be joined by mechanical fastening using fastening elements such as bolts and screws.

In the flow path forming device 10 of the above embodiments, a coolant can flow within the flow path formed in the structure 12, but it is not limited to this configuration. In the flow path forming device 10, for example, fluids other than a coolant such as a gas and an oil may flow within the flow paths.

In the flow path forming device 10 of the above embodiments, the members constituting the structure 12 are formed by injection-molding using a mold. However, the forming method of the members are not limited to injection-molding and the members may be formed by, for example, press molding.

The structure 12 of the flow path forming device 10 of the above embodiments is constituted of one single component, i.e., the structure 12, but it is not limited to this constitution. For example, the structure 12 of the flow path forming device 10 may be constituted of multiple components that are joined together. In this case, it is possible to realize a structure where three or more flow paths are offset and cross independently. The multiple components of the structure 12 may have the same flow path structure or different flow path structures. Additionally, the flow path forming device 10 may be, for example, constituted of the structure 12 joined with an object other than the structure 12.

In the above embodiments, the flow path forming device 10 is applied to a fluid control system 1 installed in an electric vehicle, but the application target of the flow path forming device 10 is not limited to the aforementioned case. The flow path forming device 10 can be applied to, for example, a system installed in a vehicle with an internal combustion engine as a power source, and a system used in a factory or a house.

In the embodiments described above, it is needless to say that the elements of the embodiments are not necessarily essential except in the case where those elements are explicitly indicated to be essential in particular, the case where those elements are considered to be obviously essential in principle, and the like.

In the embodiments described above, in a case where numerical values, such as the numbers, numerical values, amounts, and ranges, of configuration elements of the embodiments are mentioned, the specific numbers are not limitative, except for cases, such as a case where it is clearly indicated that the numerical values are particularly essential, and a case where the numerical values are obviously limited to the specific numbers in principle, and the like.

In the embodiments described above, when the shapes, positional relationships, and the like of the configuration elements and the like are mentioned, the shapes, positional relationships, and the like are not limitative, except for cases, such as a case where it is clearly indicated, and a case where the specific shapes, positional relationships, and the like are limitative in principle.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A flow path forming device comprising:
a structure including multiple fluid paths independent from each other, wherein
the multiple fluid paths include adjacent fluid paths which are adjacent to each other, offset in a predetermined assembly direction and cross each other independently, and
the structure is assembled from two separate members: a first member and a second member, which are combined in the assembly direction and joined together.

2. The flow path forming device according to claim 1, wherein
one of the adjacent fluid paths is referred to as a first flow path, and another of the adjacent fluid paths is referred to as a second flow path,
at least a part of the first flow path is enclosed by a first flow path section of the first member and a second flow path section of the second member,
the first flow path section faces the second flow path section in the assembly direction,
the second flow path is enclosed by a third flow path section of the second member, a fourth flow path section of the first member, and an intersection forming section of the second flow path section,
the fourth flow path section faces the third flow path section in the assembly direction,
the intersection forming section is provided at a position where the first flow path and the second flow path are offset and cross independently,
the first flow path and the second flow path are separated by the intersection forming section,
the first member is a molded part in which the first flow path section and the fourth flow path section are molded together, and
the second member is a molded part in which the second flow path section and the third flow path section are molded together.

3. The flow path forming device according to claim 2, wherein
the first flow path section of the first member is a first recess which is open toward the second member,
the second flow path section of the second member is a second cover which faces the first recess,
the third flow path section of the second member is a second recess which is open toward the first member, and
the fourth flow path section of the first member is a first cover which faces the second recess.

4. The flow path forming device according to claim 2, wherein
the second flow path section of the second member is a first recess which is open toward the first member,
the first flow path section of the first member is a first cover which faces the first recess,
the third flow path section of the second member is a second recess which is open toward the first member, and
the fourth flow path section of the first member is a second cover which faces the second recess.

5. The flow path forming device according to claim 2, wherein
each of the adjacent fluid paths includes
a pair of connection ports which allow a fluid to flow into or out of a fluid path from and to an external device, and
an intermediate flow path section connecting the pair of connection ports, and
intermediate flow path sections of the adjacent fluid paths, which are adjacent to each other, are offset in the assembly direction and cross independently.

6. The flow path forming device according to claim 5, wherein
the second member includes one of the pair of connection ports of the second flow path, and
the one of the pair of connection ports is open away from the first member and allows the intersection forming section to be exposed to an outside of the second member via the one of the pair of connection ports.

7. The flow path forming device according to claim 6, wherein
the first member or the second member includes another of the pair of connection ports of the second flow path that is open away from the second member or the first member.

8. The flow path forming device according to claim 5, wherein
the first member or the second member includes one of the pair of connection ports of the first flow path is open away from the second member or the first member, and
the first member or the second member includes another of the pair of connection ports of the first flow path is open away from the second member or the first member.

9. The flow path forming device according to claim 1, wherein
the first member and the second member of the structure are joined by adhesion, welding, or fusion.

10. The flow path forming device according to claim 1, wherein
a fluid flowing through the multiple fluid paths is a coolant.
